(19) United States
(12) Patent Application Publication
(10) Pub. No.: US 2016/0327195 A1
(43) Pub. Date: Nov. 10, 2016

(54) QUICK CONNECT SYSTEM FOR VENT HOSE HOOK-UP

(71) Applicants: James William Johnson, Hayden, ID (US); Patricia J Blakeman, Coeur d'Alene, ID (US)

(72) Inventors: James William Johnson, Hayden, ID (US); Patricia J Blakeman, Coeur d'Alene, ID (US)

(21) Appl. No.: 15/146,885

(22) Filed: May 4, 2016

Related U.S. Application Data
(60) Provisional application No. 62/179,278, filed on May 4, 2015.

(51) Int. Cl. F16L 37/00; F16L 37/248; F16L 21/08; F16L 43/00

(52) U.S. Cl. CPC F16L 37/004; F16L 43/001; F16L 43/008; F16L 37/248; F16L 21/08

(57) ABSTRACT

A quick connect system for vent hose hook-up is provided. In an implementation, a quick-connect member can be quickly attached to a source of airflow without using tools. The quick-connect member has a built-in clamp that attaches to the airflow source, and can be secured to the source of airflow by finger-tightening. A quick-connect lock on the other end of the quick-connect member enables a vent hose to be quickly connected to the member, also without using tools. The quick-connect lock also allows unhooking of the set-up without tools in order to clean inside ducts, vents, and hoses, and then fast reattachment without tools. The quick connect system alleviates the difficulty of connecting exit hoses to the airflow vent of a clothes dryer, in the limited and confined space behind the clothes dryer.

### RELATED APPLICATIONS

This patent application claims the benefit of priority to U.S. Provisional Patent Application No. 62/179,278 to Johnson, filed May 4, 2015, entitled, “Clothes Dryer Hook Up Extension Kit,” and incorporated herein by reference in its entirety.

### BACKGROUND

Hooking-up a clothes dryer includes providing safe passage of hot airflow away from the exhaust vent of the dryer. The hook-up usually includes holding a galvanized steel duct elbow or a vent hose onto the dryer's exhaust vent, removing the duct elbow or the vent hose to add a forgotten hose clamp around the duct elbow or the vent hose, reattaching the duct elbow or the vent hose to the dryer's exhaust vent, and tightening the hose clamp with a screwdriver while holding the duct elbow or the vent hose, before the duct elbow or the vent hose works its way off the dryer's exhaust vent. The hook-up is often performed in a confined or limited space behind the clothes dryer, with insufficient room to get proper positioning to hold the duct elbow and vent hose while tightening the hose clamp with the screwdriver. Often, the screwdriver itself will not fit in the limited space in the needed orientation to tighten the hose clamp. When a duct elbow is used, then the procedure must be repeated again up higher on the elbow or hose within the limited space behind the dryer. Periodic maintenance consisting of cleaning lint inside the duct elbow, the vent hose, and the dryer's exhaust vent is usually avoided for fear of disturbing the hose clamps and fear of the effort needed to successfully reattach and retighten the hose clamps in the limited space behind the dryer.

### SUMMARY

This disclosure describes a quick connect system for vent hose hook-up. In an implementation, a quick-connect member can be quickly attached to a source of airflow without using tools. The quick-connect member has a built-in clamp that attaches to the airflow source, and can be secured to the source of airflow by finger-tightening. A quick-connect lock on the other end of the quick-connect member enables a vent hose to be quickly connected to the member, also without using tools. The quick-connect lock also allows unhooking of the set-up without tools in order to clean inside ducts, vents, and hoses, and then fast reattachment without tools. The quick connect system alleviates the difficulty of connecting exit hoses to the airflow vent of a clothes dryer, in the limited and confined space behind the clothes dryer.

This summary is not intended to identify key or essential features of the claimed subject matter, nor is it intended to be used as an aid in limiting the scope of the claimed subject matter.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1 is a diagram of an example vent hook-up scenario, for example, for a clothes dryer.

FIG. 2 is a diagram of the example quick-connect member of FIG. 1, in greater detail.

FIG. 3 is a diagram of another implementation of the example quick-connect member, with a different embodiment of the example quick-connect clamp.

FIG. 4 is a diagram of an example quick-connect lock for securing an end of the quick-connect member, such as an elbow member, to a vent hose.

FIG. 5 is a diagram of example additional implementations of the example quick-connect lock.

### DETAILED DESCRIPTION

Overview

This disclosure describes quick connect systems for vent hose hook-ups. An example system enables quick hook-up of ductwork and vent hoses for safely conveying airflow from the output vent of a clothes dryer, for example. The example system can be quickly connected without tools, and without having to work or use tools in the limited and confined space behind a clothes dryer, for example. The example system also allows quick disconnection of ducts and vent hoses for purposes of cleaning inside the ducts and vent hoses and for periodic maintenance. The ducts and vent hoses may then be reconnected quickly, without tools.

Example Systems

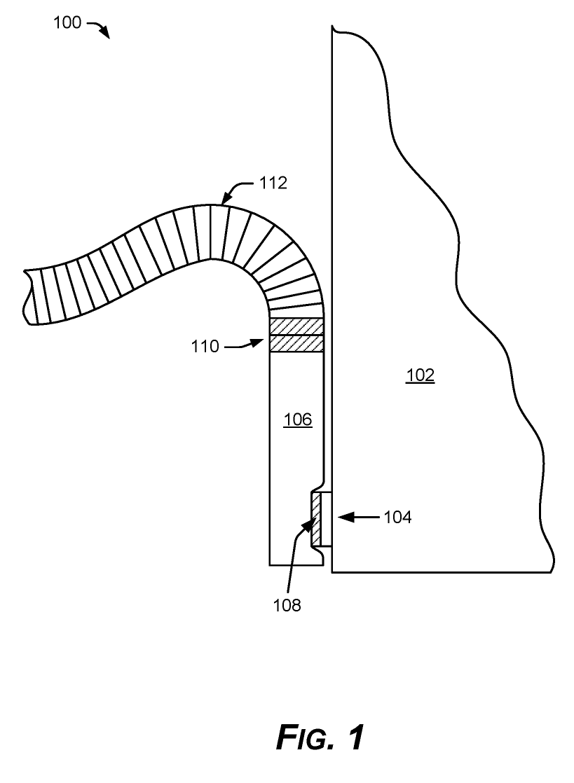

FIG. 1 shows an example vent hook-up scenario 100, for example, for a clothes dryer 102. The dryer 102 has an output vent 104, for airflow exiting the dryer 102. A quick-connect member 106 of the example system 100, such as an elbow member, has two openings, for example, for passing airflow. The quick-connect member 106 may be a linear tube, for example, with two openings at 90 degrees with respect to each other. In an implementation, the two openings are within a cross-sectional profile of the linear tube, in order to fit the quick-connect member 106 in a limited space behind a dryer 102.

One of the openings has a quick-connect clamp 108 built into or onto the opening of the quick-connect member 106. The quick-connect clamp 108 enables the quick-connect member 106 to mate with the dryer's output vent 104 and to be securely attached to the dryer's output vent 104 via finger-tightening of the quick-connect clamp 108, without the use of tools.

At the other opening of the quick-connect member 106, a quick-connect lock 110 enables a vent hose 112 to be quickly connected to the quick-connect member 106, without the use of tools. Thus, in the cramped, limited, or confined space behind a clothes dryer 102, for example, the example system 100 enables quick hook-up of the dryer venting, without use of tools.

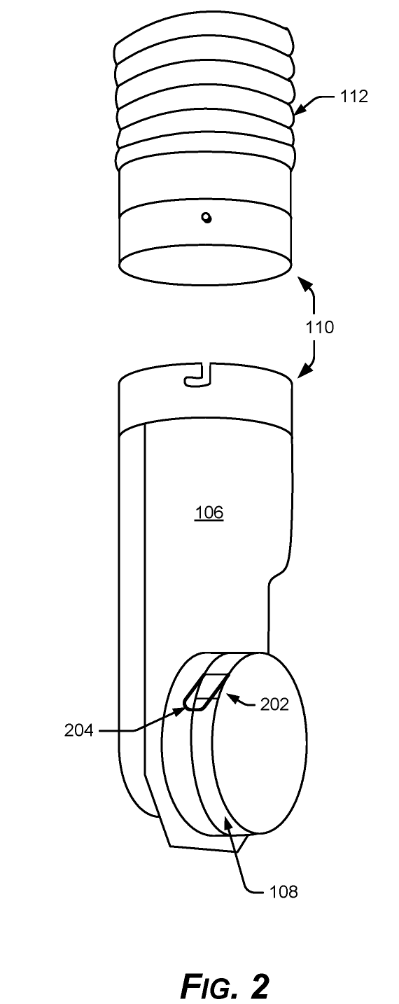

FIG. 2 shows the example quick-connect member 106 in greater detail. The example quick-connect member 106 may be an elbow member 106, or other conduit, for venting airflow from a dryer 102. A quick-connect clamp 108 allows instant tightening of the quick-connect member 106 around the dryer's output vent 104 with one or more simple finger movements of the user. The quick-connect clamp 108 may have a bail-type clamping mechanism 202 for tightening around the dryer's output vent 104. The bail-type clamping mechanism 202 has a bail 204, which is a lever that can be flipped by the user's finger from one position to another to tighten the quick-connect clamp 108 around the dryer's output vent 104. This embodiment of the example quick-connect clamp 108 may have some built-in “give” or tolerance, to compensate or provide compliance for slightly different diameters or conditions of the dryer's output vent 104. However, most dryer's output vents 104 are of a standard diameter, so the quick-connect clamp 108 can provide a very reliable seal without having to accommodate much variation in the geometry and scale of the dryer's output vent 104.

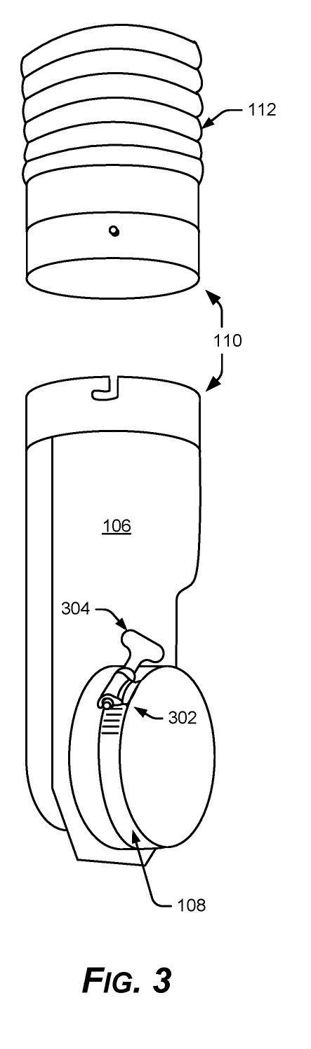

FIG. 3 shows another implementation of the example quick-connect member 106, with a different embodiment of the example quick-connect clamp 108. In this example, the quick-connect clamp 108 is a thumb screw clamp 302, which has a finger-operated turning handle 304, thumb screw, wing-nut, or key large enough to be turned sufficiently tight by a user's thumb and forefinger, for example. The various embodiments of a quick-connect clamp 108 allow the user to toollessly secure the quick-connect member 106 to the elbow member to dryer's output vent 104.

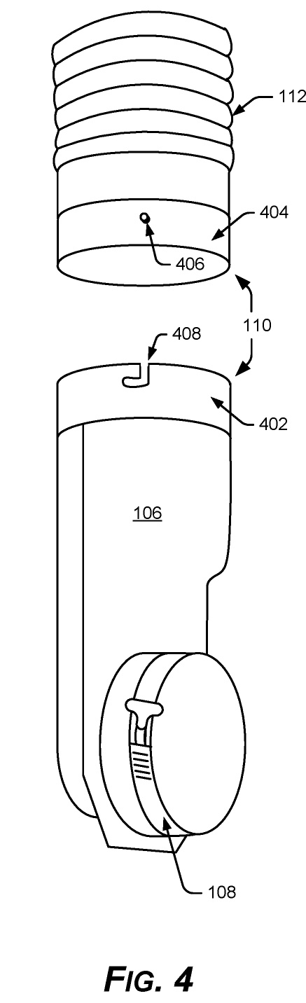

FIG. 4 shows an example quick-connect lock 110 for securing a second end of the quick-connect member 106, such as an elbow member 106, to a vent hose 112. A first part 402 of the quick-connect lock 110 may be attached to the second end of the elbow member 106. A second part 404 of the quick-connect lock 110 may be attached to a first end of the vent hose 112. The first part 402 of the quick-connect lock 110 and the second part 404 of the quick-connect lock 110 are capable of toollessly locking to each other to secure the vent hose 112 to the elbow member 106. The quick-connect lock 110 is capable of quick disconnection and reconnection for cleaning the inside of the elbow member 106, the vent hose 112, and/or the dryer's output vent 104. The quick-connect lock 110 may be a two-part turn and lock system, as shown in FIG. 4, with a cam or stud 406 on the second part 404 of the quick-connect lock 110, for instance, and a slot 408 in the first part 402 of the quick-connect lock 110 for securing the quick-connect lock 110 together via the cam or stud 406, for example, without tools.

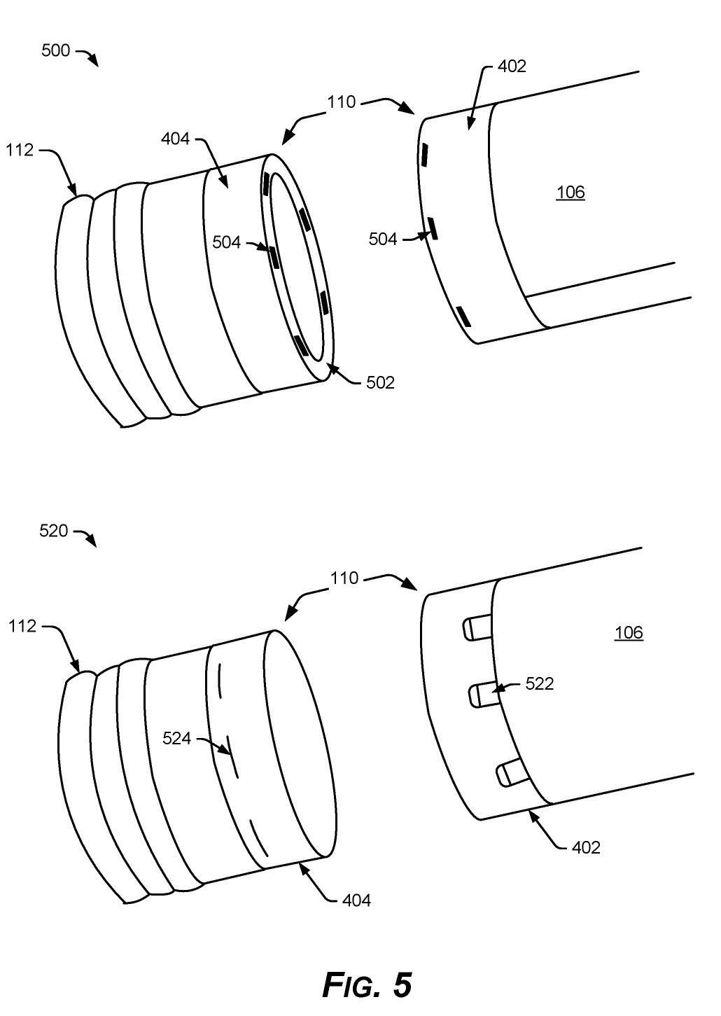

FIG. 5 shows additional implementations of the example quick-connect lock 110. For example, the quick-connect lock 110 may be a two-part magnetic lock system 500, in which an end of the quick-connect member 106 having the first part of the quick-connect lock 110 fits in a groove 502 of the second part of the quick-connect lock 110 attached to the vent hose 112. Magnets 504 in both parts of the quick-connect lock 110 can be engaged or disengaged to lock or unlock the quick-connect lock 110 by rotating the joint so that the magnets 504 either align or misalign with each other.

In a clip version 520 of the example quick-connect lock 110, clips 522 and raised bumps or ridges, or alternatively, indentations, enable the clip system 520 to lock the example quick-connect member 106 to the vent hose 112.

In an implementation, an additional quick-connect clamp 108 is disposed on a second end of the vent hose 112 for toollessly securing the vent hose 112 to an outlet fixture of a wall, a ceiling, or a floor.

The quick-connect member 106, or elbow member, may be composed of formed sheet metal or a molded plastic, or even firm rubber. In another example, the first part 402 of the quick-connect lock 110 attached to the second end of the elbow member 106 is composed of a metal, while the complementary second part 404 of the quick-connect lock 110 attached to a length of the vent hose 112 is composed of a plastic, such as ABS plastic or a polybutylene or polypropylene plastic.

An example quick-connect system 100 may be packaged as a dryer hook-up kit, including an elbow member, a vent hose, a quick-connect clamp built into a first end of the elbow member for securing the elbow member to a dryer exhaust vent without tools, a first part of a quick-connect lock built into a second end of the elbow member, a second part of the quick-connect lock attachable to a length of the vent hose without tools, and the first part of the quick-connect lock and the second part of the quick-connect lock capable of locking to each other without tools to secure the vent hose to the elbow member while communicating an airflow from the dryer exhaust vent, for example. The dryer hook-up kit may include an additional quick-connect clamp attachable to the length of the vent hose for securing the vent hose to an outlet fixture of a wall, a ceiling, or a floor without tools. Likewise, the dryer hook-up kit may include an extender piece to vary a distance between the elbow member and the dryer exhaust vent, the extender piece being quick-connectable to the quick-connect clamp of the elbow piece and having a quick-connect clamp built into one end of the extender piece for quick-connecting to the dryer exhaust vent.

The example system 100 is not limited to clothes dryers, but may include a quick-connect member capable of connecting to a generic airflow vent without tools and capable of redirecting an airflow from the airflow vent, and a quick-connect lock capable of locking the quick-connect member to a vent hose without tools while communicating an airflow through the quick-connect lock. A first part of quick-connect lock can be built into the quick-connect member, and a second part of the quick-connect lock is capable of being attached to the vent hose without tools. The example system 100 is unlockable without tools to allow cleaning of an inside of the quick-connect member, the vent hose, and the source of the airflow.

In the specification and appended claims: the terms “connect,” “connection,” “connected,” “in connection with,” and “connecting,” are used to mean “in direct connection with” or “in connection with via one or more elements.” The terms “couple,” “coupling,” “coupled,” “coupled together,” and “coupled with,” are used to mean “directly coupled together” or “coupled together via one or more elements.”

While the present disclosure has been disclosed with respect to a limited number of embodiments, those skilled in the art, having the benefit of this disclosure, will appreciate numerous modifications and variations possible given the description. It is intended that the appended claims cover such modifications and variations as fall within the true spirit and scope of the disclosure.

1. An apparatus, comprising:
an elbow member for venting an airflow from a dryer;
a first quick-connect clamp on a first end of the elbow member for toollessly securing the elbow member to the dryer;
a quick-connect lock for securing a second end of the elbow member to a vent hose;
a first part of the quick-connect lock attached to the second end of the elbow member;
a second part of the quick-connect lock attached to a first end of the vent hose; and
the first part of the quick-connect lock and the second part of the quick-connect lock capable of toollessly locking to each other to secure the vent hose to the elbow member.

2. The apparatus of claim 1, wherein the elbow member comprises a linear tube with two openings at 90 degrees with respect to each other.

3. The apparatus of claim 2, wherein each of the two openings are within a cross-sectional profile of the linear tube.

4. The apparatus of claim 1, further comprising a second quick-connect clamp on a second end of the vent hose for toollessly securing the vent hose to an outlet fixture of a wall, a ceiling, or a floor.

5. The apparatus of claim 4, wherein the first and second quick-connect clamps comprise thumb screw clamps.

6. The apparatus of claim 4, wherein the first and second quick-connect clamps comprise finger-actuated bail clamps.

7. The apparatus of claim 1, wherein the quick-connect lock comprises a two-part turn and lock system.

8. The apparatus of claim 1, wherein the quick-connect lock comprises a two-part magnetic lock system.

9. The apparatus of claim 1, wherein the quick-connect lock comprises one or more clips.

10. The apparatus of claim 1, wherein the elbow member comprises a formed sheet metal member or a molded plastic member.

11. The apparatus of claim 1, wherein the first part of the quick-connect lock attached to the second end of the elbow member comprises a metal; and
the complementary second part of the quick-connect lock attached to the first end of the vent hose comprises a plastic.

12. A dryer hook-up kit, comprising:
an elbow member;
a vent hose;
a quick-connect clamp built into a first end of the elbow member for securing the elbow member to a dryer exhaust vent without tools;
a first part of a quick-connect lock built into a second end of the elbow member;
a second part of the quick-connect lock attachable to a length of the vent hose without tools; and
the first part of the quick-connect lock and the second part of the quick-connect lock capable of locking to each other without tools to secure the vent hose to the elbow member while communicating an airflow from the dryer exhaust vent.

13. The dryer hook-up kit of claim 12, wherein the elbow member comprises a linear tube with two airflow openings in planes at 90 degrees with respect to each other.

14. The dryer hook-up kit of claim 13, wherein each of the two openings are within a cross-sectional profile of the linear tube.

15. The dryer hook-up kit of claim 12, further comprising an additional quick-connect clamp attachable to the length of the vent hose for securing the vent hose to an outlet fixture of a wall, a ceiling, or a floor without tools.

16. The dryer hook-up kit of claim 12, wherein the quick-connect clamp is selected from the group consisting of a thumb screw clamp and a finger-actuated bail clamp.

17. The dryer hook-up kit of claim 12, wherein the quick-connect lock is selected from the group consisting of a two-part turn and lock system, a two-part magnetic lock system, and a clip system.

18. The dryer hook-up kit of claim 12, further comprising an extender piece to vary a distance between the elbow member and the dryer exhaust vent, the extender piece being quick-connectable to the quick-connect clamp of the elbow piece and having a quick-connect clamp built into one end of the extender piece for quick-connecting to the dryer exhaust vent.

19. A system, comprising:
a quick-connect member capable of connecting to an airflow vent without tools and capable of redirecting an airflow from the airflow vent;
a quick-connect lock capable of locking the quick-connect member to a vent hose without tools while communicating an airflow through the quick-connect lock;
a first part of the quick-connect lock built into the quick-connect member; and
a second part of the quick-connect lock capable of being attached to the vent hose without tools.

20. The system of claim 19, wherein the quick-connect lock is unlockable to allow cleaning of an inside of the quick-connect member and the vent hose.
